(19) United States
(12) Patent Application Publication
(10) Pub. No.: US 2002/0076552 A1
(43) Pub. Date: Jun. 20, 2002

(54) Self-wound thermal transferable over-laminating tape

(76) Inventor: Tong Chee Hsu, Irvine, CA (US)

Correspondence Address: Price And Gess, Suite 250, 2100 S.E. Main Street, Irvine, CA, 92614-6238, US

(21) Appl. No.: 09/742,498

(22) Filed: Dec. 20, 2000

(51) Int. Cl. B32B 7/12; B32B 9/00; B32B 15/04; B32B 33/00

(52) U.S. Cl. 428/355 AC; 428/41.8; 428/343; 428/352

(57) ABSTRACT

The present invention is a self-wound thermal transferable over-laminating (OL) tape, preferably for receiving a thermal transfer image from a thermal transfer ink ribbon and preferably using pressure-sensitive-adhesive (PSA). The preferred embodiment of the OL PSA tape comprises a layer of plastic film with two opposing sides. The first opposing side of the plastic film contacts a printable release coating comprising clear polyamide-carbamate receptive to wax-type, resin-type and wax-resin hybrid thermal transfer inks. The second opposing side of the plastic film contacts a pressure-sensitive-adhesive. The pressure sensitive adhesive is, preferably, acrylic adhesive.

### TECHNICAL FIELD

The present invention is a self-wound thermal transferable over-laminating (OL) tape, preferably for receiving a thermal transfer image from a thermal transfer ink ribbon and preferably using pressure-sensitive-adhesive (PSA).

### BACKGROUND ART

In general, labels, such as for packaging, comprise an overlaminating protective layer and an underlying layer of ink and labelstock. The overlaminating protective layer is typically over-laminated (OL) pressure-sensitive-adhesive (PSA) tape, commonly referred to as OL PSA tape. OL PSA tape comprises a plastic film layer coated with a PSA.

OL PSA tape may be stored on a separate disposable liner in juxtaposed face-to-face contact with the PSA. The disposable liner is either itself adhesive-resistant or a release coating is placed on the disposable liner on the side of the liner in contact with the PSA. Just prior to use, the disposable liner is peeled away from the PSA.

Alternatively, the OL PSA tape can be a plastic film coated on one side with a release coating and on the other side with a PSA. Such a linerless tape can be stored in pads or rolls and is commonly called, “self-wound.” If the tape is self-wound, the PSA has to release without residue from the release coating on the opposite side of the plastic film.

During label printing, the OL PSA tape is typically applied to printed labelstock just prior to die cutting the labels. The finished label is then dispensed onto the article to be labeled. The plastic film of the OL PSA tape is the outermost layer of the label and serves to protect the underlying ink and label.

Currently, there is a frequent need to print variable information on finished labels. For example, bar codes and expiration dates are commonly applied to labels prior to the dispensing of the labels onto products. Color images can also be applied to labels using color thermal transfer ink ribbons and the technique of hot stamping.

There are generally three types of thermal transfer inks used: wax, resin and wax-resin hybrids. Each differs in cost and performance. Wax inks are used in the majority of applications. When a label has overlamination and has to receive thermal transfer ink, the following options for tapes are available in the prior art:

1) Thermal transferable overlaminate tapes on a release liner (such as FASSON™ 61317). This is generally expensive to use.

2) Polyester film self-wound OL tape such as Sekisui TA Industries, Inc.'s model 1430 tape. However, it will receive resin-type inks only under relatively slower printing speeds.

3) U.S. Pat. No. 5,478,880 to Shipston et al describes a printable release coating which accepts thermal transfer inks. However, the release coating is not clear enough to use with an overlaminating tape.

4) Self-wound polypropylene OL tape. This tape generally requires special ink ribbons and printing at higher temperatures.

Other prior art patents regarding various types of tape are U.S. Pat. Nos. 5,496,635, 5,429,850, 5,168,002, 4,725,454, 4,708,907, 4,617,199, 4,587,167, 4,587,156, 4,379,806, 3,725,121, and 3,241,662 and U.K. Patent No. 2,103,513.

A low-cost, self-wound OL PSA tape with a clear release coating that will receive various types of thermal transfer inks is desirable.

### SUMMARY OF THE INVENTION

The present invention is a self-wound thermal transferable over-laminating (OL) tape, preferably for receiving a thermal transfer image from a thermal transfer ink ribbon and preferably using pressure-sensitive-adhesive (PSA). The preferred embodiment of the OL PSA tape comprises a layer of plastic film with two opposing sides. The first opposing side of the plastic film contacts a printable release coating comprising clear polyamide-carbamate receptive to wax-type, resin-type and wax-resin hybrid thermal transfer inks. The second opposing side of the plastic film contacts a pressure-sensitive-adhesive. The pressure sensitive adhesive is, preferably, acrylic adhesive.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a cross-sectional view of a preferred embodiment of the invention.

FIG. 2 is a perspective view of a preferred storage mode of the invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a self-wound thermal transferable over-laminating (OL) tape, preferably for receiving a thermal transfer image from a thermal transfer ink ribbon and preferably using pressure-sensitive-adhesive (PSA).

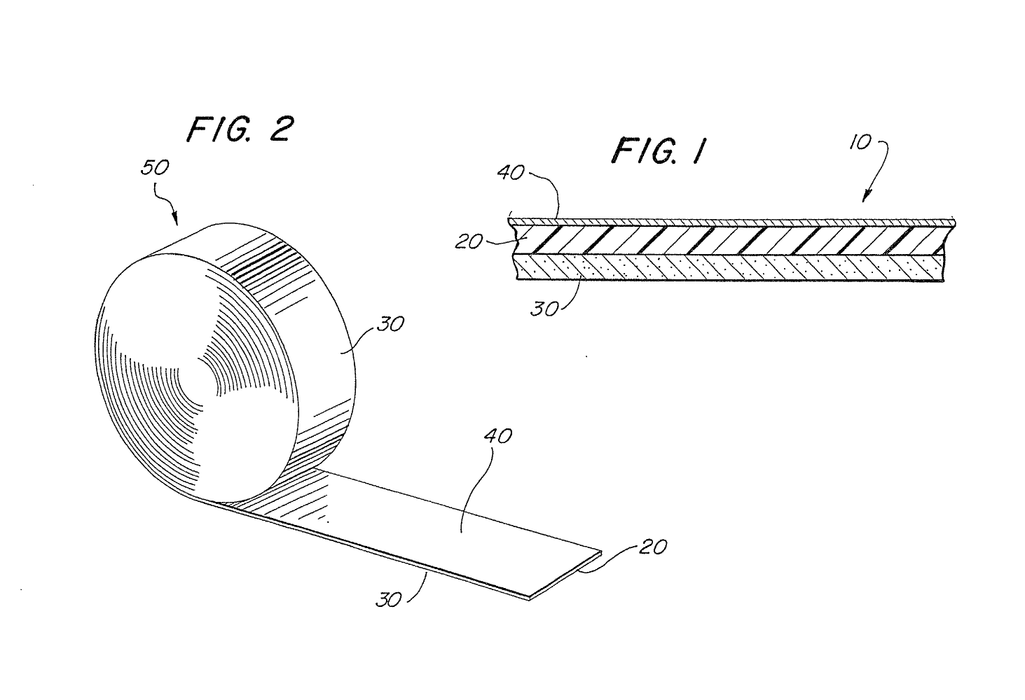

Referring now to FIG. 1, a piece 10 of OL PSA tape is shown. The OL PSA tape comprises a middle layer of plastic film 20. The plastic film 20 is preferably polyester or polypropylene. Polypropylene has performance and cost-advantages. However, the plastic film 20 need not be limited to either polyester or polypropylene. The plastic film is typically 15 to 50 microns in thickness. However, this invention is not limited by the thickness of the plastic film 20.

The lower layer 30 is a pressure sensitive adhesive (PSA). The PSA 30 is preferably acrylic adhesive. The preferred type of PSA 30 is Union Carbide's 9604 adhesive or Rohm and Haas's PS90 adhesive. The PSA 30 is typically 5-35 microns in thickness. However, this invention is not limited by the thickness of the PSA 30.

The top layer 40 is a release coating. The release coating 40 is polyamide-carbamate. The release coating 40 is preferably 0.1 to 2 microns in thickness. The release coating 40 is found to receive all thermal transfer inks well, especially wax type and resin-wax types. Thermal transfer inks, especially the wax type, bond with the release coating 40 through two mechanisms: chemical compatibility and slight melting of the release coating 40 when thermal transfer printing is done at higher temperatures. The release coating 40 has a refractive index near that of the plastic film 20 so as not to diminish the view of printing on labelstock under the OL PSA tape 10.

Preferably, the release coating 40 is RA-50 from Mayzo. However, any printable release coating designed for packaging tape will work for this overlaminating tape, in particular the release coatings described in U.S. Pat. Nos. 5,168,002 and 4,578,167 to Vibac and U.S. Pat. Nos. 4,725,454, 4,617,199, and 4,594,277 to Manuli.

Referring to FIG. 2, the present invention is shown in a preferred storage mode of a self-wound roll 50. As shown, the PSA 30 is incompatible with the release coating 40 in order to avoid excessive bonding so that the OL PSA tape 10 will unroll easily and without leaving residue from the release coating 40 that impedes the function of the PSA 30.

A preferred method of manufacturing OL PSA tape 10 is described below. First, a printable release coating 40, preferably RA-50 from Mayzo, is applied to one side of a layer of plastic film 20. The release coating 40 on plastic film 20 is allowed to dry. Next, a pressure-sensitive adhesive 30, preferably acrylic adhesive, is applied to the side of the plastic film 20 opposite the release coating 40. The OL PSA tape 10 is allowed to dry. The OL PSA tape 10 is then wound into a roll 50 as is depicted in FIG. 2.

Thus, a self-wound overlaminating pressure-sensitive adhesive tape is described above usable with a variety of thermal transfer inks. In each of the above embodiments, the different positions and structures of the present invention are described separately in each of the embodiments. However, it is the full intention of the inventor of the present invention that the separate aspects of each embodiment described herein may be combined with the other embodiments described herein. Those skilled in the art will appreciate that adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. An over-laminating pressure-sensitive-adhesive tape comprising the following:
a layer of plastic film with two opposing sides;
the first opposing side contacting a releasing coating; said release coating comprising polyamide-carbamate; and,
the second opposing side contacting a pressure-sensitive-adhesive.

2. The tape of claim 1 where the release coating is clear.

3. The tape of claim 1 where the tape is self-wound.

4. The tape of claim 1 where the pressure-sensitive-adhesive is acrylic adhesive.

5. The tape of claim 1 where the release coating is receptive to wax-type thermal transfer ink.

6. The tape of claim 1 where the release coating is receptive to resin-type thermal transfer ink.

7. The tape of claim 1 where the release coating is receptive to resin-wax hybrid thermal transfer ink.

8. A self-wound overlaminating pressure-sensitive-adhesive tape comprising the following:
a layer of plastic film with two opposing sides; the first opposing side contacting a release coating; said release coating comprising clear polyamide-carbamate receptive to wax-type, resin-type and wax-resin hybrid thermal transfer inks; and,
the second opposing side contacting a pressure-sensitive-adhesive.

9. The tape of claim 8 where the pressure-sensitive-adhesive is acrylic adhesive.

10. The tape of claim 8 where the plastic film is polyester.

11. The tape of claim 8 where the plastic film is polypropylene.

12. A method of manufacturing self-wound, overlaminating pressure-sensitive-adhesive tape comprising the following steps:
applying a release coating having polyamide-carbamate to one side of a layer of plastic film having two opposing sides;
drying the release coating and plastic film;
applying pressure-sensitive-adhesive to the opposing side of the layer of plastic film;
drying the pressure-sensitive adhesive on the layer of plastic film; and
winding the release coating, plastic film and pressure-sensitive-adhesive.

13. The method of claim 12 where the pressure-sensitive adhesive is acrylic adhesive.

14. The method of claim 12 where the release coating is clear.

15. The method of claim 12 where the plastic film is polyester.

16. The method of claim 12 where the plastic film is polypropylene.

17. The method of claim 12 where the release coating is receptive to wax-type thermal transfer ink.

18. The method of claim 12 where the release coating is receptive to resin-type thermal transfer ink.

19. The method of claim 12 where the release coating is receptive to resin-wax hybrid thermal transfer ink.
